(19) United States
(12) Patent Application Publication
(10) Pub. No.: US 2017/0174006 A1
(43) Pub. Date: Jun. 22, 2017

(54) STEEL REINFORCING ELEMENT COATED WITH AN ADHESIVE COMPOSITION CONTAINING AROMATIC ALDEHYDE AND POLYPHENOL

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: CLÉMENT MICHOUD, CLERMONT-FERRAND (FR); DAVID DOISNEAU, CLERMONT-FERRAND (FR)

(73) Assignees: Michelin Recherche et Technique S.A., GRANGES-PACCOT (CH); COMPAGNIE GNERALE DES ETABLISSEMENTS MICHELIN, CLERMONT-FERRAND (FR)

(21) Appl. No.: 15/116,992

(22) PCT Filed: Feb. 5, 2015
(86) PCT No.: PCT/EP2015/052360

§ 371 Date: Aug. 5, 2016

(30) Foreign Application Priority Data
Feb. 6, 2014 (FR) 1450900

(51) Int. Cl. B60C 9/00; C09J 109/08; C09J 107/02; B32B 15/06; B32B 7/12

(52) U.S. Cl. CPC B60C 9/0007; B32B 15/06; B32B 7/12; C09J 107/02; C09J 109/08; B60C 2009/0021; B32B 2255/06; B32B 2255/26; B32B 2605/08

(57) ABSTRACT

The steel reinforcing element is coated with an adhesive layer coating at least a portion of the reinforcing element. The adhesive layer comprises an adhesive composition comprising: at least one unsaturated elastomer latex, and at least one phenol/aldehyde resin based on at least one aromatic aldehyde and one polyphenol comprising one or more aromatic nucleus/nuclei.

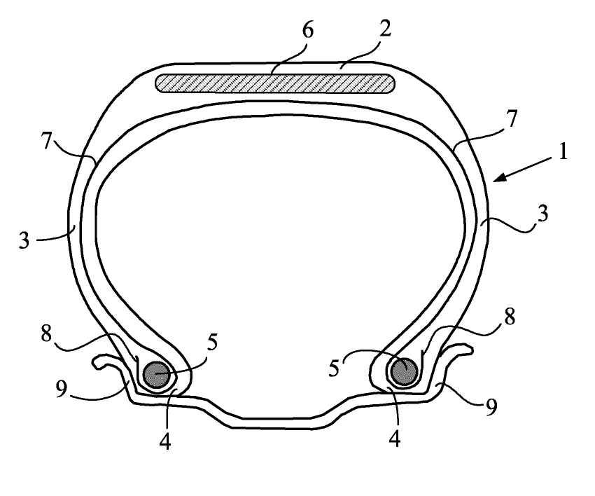

The field of the present invention is that of metal reinforcing elements and adhesive compositions or “adhesives” intended to make such metal reinforcing elements adhere to unsaturated rubber matrices, such as those commonly used in rubber articles or semi-finished products.

The present invention relates more particularly to steel reinforcing elements coated with adhesive layers based on a phenol/aldehyde resin, in particular to coated steel reinforcing elements capable of reinforcing tyre structures.

Steel reinforcing elements for tyres comprising one or more threadlike reinforcing elements made of steel, for example steel wires, are known from the state-of-the-art. It is known to make these steel wires adhere to rubber compositions by virtue of the use of adhesives known under the name “RFL” (for resorcinol-formaldehyde latex), such as, for example, in EP 2 006 341. These RFL adhesives comprise, in a well-known way, a thermosetting phenolic resin, obtained by the condensation of resorcinol with formaldehyde, and one or more latexes of diene rubber in aqueous solution.

The RFL adhesives of EP 2 006 341 ensure good adhesion of the coated steel wire or wires to rubber matrices without these wires being surface-treated, that is to say in the absence of a layer of a metal coating, for example a layer of brass. However, the RFL adhesive requires the use of a halogenated polymer and of a metal oxide. In addition, this RFL adhesive requires the use of a rubber matrix comprising an acrylic rubber composition and thus does not make possible satisfactory adhesion with any rubber matrix.

Thus, the designers of rubber articles, in particular tyre manufacturers, have the objective today of finding novel simple adhesive systems which make it possible to make metal reinforcing elements adhere satisfactorily to rubber matrices, without the latter necessarily being based on an acrylic rubber composition or without having to use the adhesive in combination with a halogenated polymer and a metal oxide.

In point of fact, during their research studies, the Applicant Companies have discovered an adhesive composition which makes it possible to meet the above objective.

Thus, a first subject-matter of the invention is a steel reinforcing element coated with an adhesive layer coating at least a portion of the reinforcing element, the adhesive layer comprising an adhesive composition comprising:
at least one unsaturated elastomer latex, and
at least one phenol/aldehyde resin based on at least:
   one aromatic aldehyde bearing at least one aldehyde functional group, comprising at least one aromatic nucleus;
   one polyphenol comprising one or more aromatic nucleus/nuclei, it being understood that:
      in the case of just one aromatic nucleus, the latter bears two or three hydroxyl functional groups in the meta position with respect to each other or with respect to one another, the remainder of the aromatic nucleus being unsubstituted;
      in the case of several aromatic nuclei, at least two of them each bear two or three hydroxyl functional groups in the meta position with respect to each other or with respect to one another, it being understood that the two positions ortho to at least one of these hydroxyl functional groups are unsubstituted.

The invention also relates to a process for the manufacture of a steel reinforcing element coated at least in part with an adhesive layer. The process according to the invention comprises a stage of coating at least a portion of the steel reinforcing element with the adhesive layer comprising an adhesive composition as described above.

In addition, the invention relates to the use, for the adhesion of a steel reinforcing element to a rubber matrix, of an adhesive composition as described above forming an adhesive layer coating at least in part the steel reinforcing element.

Another subject-matter of the invention is a rubber composite reinforced with at least one coated steel reinforcing element as described above comprising a rubber matrix in which the coated steel reinforcing element is embedded.

Another subject-matter of the invention is a tyre comprising at least one rubber composite as described above.

The invention thus relates to any rubber composite (article or semi-finished product), in particular any tyre, before and after curing (for final crosslinking or vulcanization), comprising a coated steel reinforcing element as described above.

The invention also relates to the use of the coated steel reinforcing element as described above as reinforcing element for rubber articles or semi-finished products, in particular tyres, especially those intended to equip motor vehicles of passenger type, SUVs (“Sport Utility Vehicles”), two-wheel vehicles (in particular bicycles and motorcycles), aircraft, as for industrial vehicles chosen from vans, heavy-duty vehicles, that is to say, underground trains, buses, heavy road transport vehicles (lorries, tractors, trailers) or off-road vehicles, such as heavy agricultural vehicles or earthmoving equipment, or other transportation or handling vehicles.

The invention and its advantages will be easily understood in the light of the description and implementational examples which follow.

In the present description, unless expressly indicated otherwise, all the percentages (%) shown are % by weight.

“Diene” elastomer (or, without distinction, rubber) is understood to mean an elastomer resulting at least in part (that is to say, a homopolymer or a copolymer) from diene monomer(s) (i.e., monomers bearing two conjugated or non-conjugated carbon-carbon double bonds). “Isoprene elastomer” is understood to mean an isoprene homopolymer or copolymer, in other words a diene elastomer selected from the group consisting of natural rubber (NR), synthetic polyisoprenes (IRs), various isoprene copolymers and the mixtures of these elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### I—Coated Steel Reinforcing Element

The expression “composition based on” should, of course, be understood as meaning a composition comprising the mixture and/or the reaction product of the various base constituents used for this composition, it being possible for some of them to be intended to react or capable of reacting with one another or with their immediate chemical surroundings, at least partly, during the various phases of manufacture of the composition, of the reinforcing element or of the composites or finished articles, in particular during a curing stage.

The coated steel reinforcing element according to the invention can comprise, in one embodiment, a single threadlike reinforcing element. In another embodiment, the coated steel reinforcing element according to the invention comprises several threadlike reinforcing elements assembled together, for example by braiding or twisting. Mention will be made, among the coated steel reinforcing elements comprising several threadlike reinforcing elements, for example, of layered cords and multistrand cords. Each threadlike reinforcing element is unitary, that is to say that the constituents of each threadlike reinforcing element are inseparable from one another.

The term “threadlike reinforcing element” is understood to mean the elongate elements of great length relative to their cross-section, whatever the shape, for example circular, oblong, rectangular or square, or even flat, of the latter, it being possible for this threadlike element to be straight or not straight, for example twisted or wavy. When it is circular in shape, the diameter of each threadlike reinforcing element is preferably less than 5 mm, more preferably within a range extending from 0.1 to 0.5 mm. Mention will also be made of the strips or bands which exhibit a great length with respect to their thickness.

In a preferred embodiment, the coated reinforcing element comprises one or more threadlike reinforcing elements each comprising a steel core. The steel core is monolithic, that is to say that it is, for example, made as one piece or moulded.

The adhesive layer coats at least a portion of the or each threadlike reinforcing element. Thus, the adhesive layer can partially or completely coat the or each threadlike reinforcing element. Thus, in the embodiment in which the coated steel reinforcing element comprises a single threadlike reinforcing element, the adhesive layer can coat some portions of this element or else the whole of it. In the embodiment in which the coated steel reinforcing element comprises several threadlike reinforcing elements, the adhesive layer can coat several threadlike elements without coating others of them or else can coat solely some portions of some or all of the threadlike elements.

The steel can exhibit a perlitic, ferritic, austenitic, bainitic or martensitic microstructure or a microstructure resulting from a mixture of these microstructures.

Preferably, the steel comprises a carbon content ranging from 0.2% to 1% by weight and more preferably from 0.3% to 0.7% by weight. Preferably, the steel comprises a manganese content ranging from 0.3% to 0.7% by weight, a silicon content ranging from 0.1% to 0.3% by weight, a phosphorus content ranging at most up to 0.045%, limit included, by weight, a sulphur content ranging at most up to 0.045%, limit included, by weight and a nitrogen content ranging at most up to 0.008%, limit included, by weight. Optionally, the steel comprises at most 0.1%, limit included, preferably 0.05%, limit included, and more preferably 0.02%, limit included, by weight of vanadium and/or molybdenum.

In one embodiment, the steel used comprises less than 0.5%, preferably at most 0.05%, limit included, and more preferably at most 0.02%, limit included, by weight of chromium.

In another embodiment using “stainless” steel, the steel comprises at least 0.5%, limit included, preferably at least 5%, limit included, and more preferably at least 15%, limit included, by weight of chromium.

Preferably, the steel comprises at least 2%, limit included, preferably at least 4%, limit included, and more preferably at least 6% by weight of nickel.

In another embodiment, the adhesive layer directly coats a layer of a metal coating directly coating at least a portion of the steel core of the or each threadlike reinforcing element. The metal of the layer of the metal coating is made of a metal other than steel.

Preferably, the metal of the layer of the metal coating directly coating at least a portion of the steel core of the or each threadlike reinforcing element is chosen from zinc, copper and the alloys of these metals. Mention will be made, as example of alloys of these metals, of brass.

In another embodiment, the adhesive layer directly coats a nonmetallic intermediate adhesive layer coating at least a portion of the steel core of the or each threadlike reinforcing element. In an alternative form of this embodiment, the nonmetallic intermediate adhesive layer directly coats at least a portion of the layer of the metal coating directly coating at least a portion of the steel core of the or each threadlike reinforcing element. The nonmetallic intermediate layer, generally known as adhesion primer, makes it possible, in combination with the adhesive layer comprising the adhesive composition, to improve the adhesion of the coated steel reinforcing element to the rubber matrix. Such adhesion primers are those commonly used by a person skilled in the art for the presizing of certain textile fibres (polyester, for example PET, aramid or aramid/nylon fibres). For example, use could be made of an epoxy-based primer, in particular a primer based on polyglycerol polyglycidyl ether. Use could also be made of a primer based on blocked isocyanate.

Layer “directly” coating an object or coating “directly” coating an object is understood to mean that the layer or the coating is in contact with the object without any other object, in particular another layer or another coating, being interposed between the two.

The adhesive composition thus comprises at least one (that is to say, one or more) phenol/aldehyde resin, based on at least one (that is to say, one or more) aromatic aldehyde and at least one (that is to say, one or more) polyphenol, and at least one (that is to say, one or more) unsaturated elastomer latex, which constituents will be described in detail below.

### I.1—Aromatic Aldehyde

The first constituent of the phenol/aldehyde resin is an aromatic aldehyde bearing at least one aldehyde functional group, comprising at least one aromatic nucleus.

According to a preferred embodiment, the aromatic nucleus bears the aldehyde functional group.

Preferably, the aromatic aldehyde bears at least two aldehyde functional groups. Preferably, the aromatic nucleus of the aromatic aldehyde bears two aldehyde functional groups, it being possible for the latter to be in the ortho, meta or para position on the aromatic nucleus.

Preferably, the aromatic nucleus of the aromatic aldehyde is a benzene nucleus. In some embodiments, this aromatic aldehyde is selected from the group consisting of 1,2-benzenedicarboxaldehyde, 1,3-benzenedicarboxaldehyde, 1,4-benzenedicarboxaldehyde, 2-hydroxybenzene-1,3,5-tricarbaldehyde and the mixtures of these compounds.

More preferably still, the aromatic polyaldehyde used is 1,4-benzenedicarboxaldehyde, also called terephthaldehyde, as a reminder of expanded chemical formula:

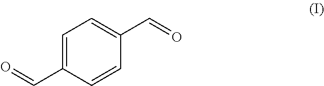

In other embodiments, the aromatic aldehyde exhibits the formula (A):

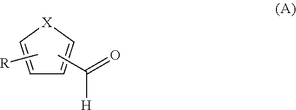

in which X comprises N, S or O and R represents —H or —CHO.

Such aromatic aldehydes result from renewable resources and not from oil. The aromatic aldehydes result, for example, from biobased resources or from products of the transformation of biobased sources.

Preferably, the aromatic aldehyde is of general formula (A′):

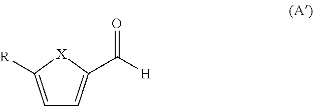

According to a preferred embodiment, X represents 0.

In an alternative form of the aromatic aldehyde of general formula (A), X represents O and R represents —H. The aromatic aldehyde used is then of formula (B1):

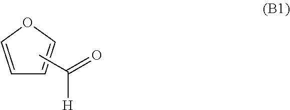

In an alternative form of the aromatic aldehyde of general formula (A′), X represents O and R represents —H. The aromatic aldehyde used is then furfuraldehyde and is of formula (B′1):

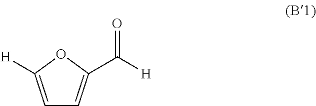

In another alternative form of the aromatic aldehyde of general formula (A), X represents O and R represents —CHO. The aromatic aldehyde used is then of formula (B2):

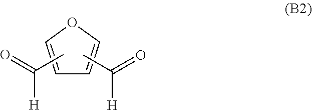

In another alternative form of the aromatic aldehyde of general formula (A′), X represents O and R represents —CHO. The aromatic aldehyde used is then 2,5-furandicarboxaldehyde and is of formula (B′2):

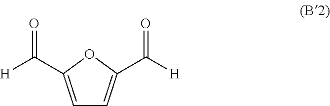

In another embodiment, X comprises N.

In an alternative form of the aromatic aldehyde of general formula (A), X represents NH. The aromatic aldehyde used is of formula (C1):

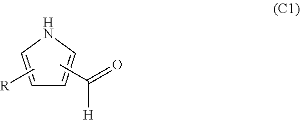

In an alternative form of the aromatic aldehyde of general formula (A′), X represents NH. The aromatic aldehyde used is of formula (C′1):

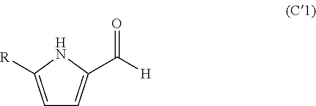

Preferably, R represents —CHO in the alternative form of the aromatic aldehyde of formula (C′1) and the aromatic aldehyde obtained is then 2,5-1H-pyrroledicarboxaldehyde.

In another alternative form of the aromatic aldehyde of general formula (A), X represents NR1 with R1 representing an alkyl, aryl, arylalkyl, alkylaryl or cycloalkyl group. The aromatic aldehyde used is of formula (C2):

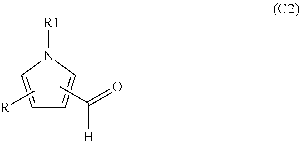

In another embodiment, X comprises S.

In an alternative form of the aromatic aldehyde of general formula (A), X represents S. The aromatic aldehyde used is of formula (D1):

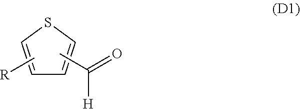

In an alternative form of the aromatic aldehyde of general formula (A′), X represents S. The aromatic aldehyde used is of formula (D′1):

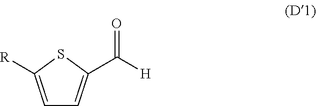

Preferably, R represents —CHO in the alternative form of the aromatic aldehyde of formula (D′1) and is then 2,5-thiophenedicarboxaldehyde.

In another alternative form of the aromatic aldehyde of general formula (A), X represents SR2 with R2 representing an alkyl, aryl, arylalkyl, alkylaryl or cycloalkyl group. The aromatic aldehyde used is of formula (D2):

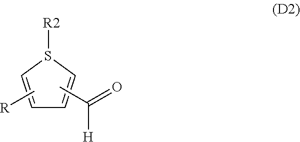

In yet another alternative form of the aromatic aldehyde of general formula (A), X represents R3-S—R2 with R2 and R3 representing, each independently of one another, an alkyl, aryl, arylalkyl, alkylaryl or cycloalkyl group. The aromatic aldehyde used is of formula (D3):

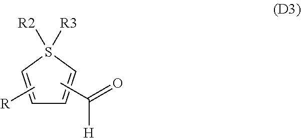

In yet another alternative form of the aromatic aldehyde of general formula (A), X represents S═O. The aromatic aldehyde used is of formula (D4):

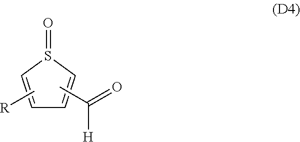

In yet another alternative form of the aromatic aldehyde of general formula (A), X represents O═S═O. The aromatic aldehyde used is of formula (D5):

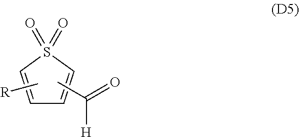

Among the different embodiments described above, preference will be given to the embodiments and alternative forms in which X represents NH, S or O. In these embodiments and alternative forms, it will be possible to have R representing —H or —CHO and preferably R representing —CHO. In these embodiments and alternative forms, R will preferably be in the 5 position and the —CHO group will preferably be in the 2 position on the aromatic nucleus (general formula (A′)).

The phenol/aldehyde resin could comprise a mixture of the compounds indicated above, in particular a mixture of furfuraldehyde and 2,5-furandicarboxaldehyde.

Preferably, when the phenol/aldehyde resin is based on a single aromatic aldehyde, the composition is devoid of formaldehyde.

When the phenol/aldehyde resin is based on several aldehydes, at least one of which is an aromatic aldehyde, each aldehyde is preferably different from formaldehyde. The composition is then also preferably devoid of formaldehyde.

In other words and preferably, the or each aldehyde of the phenol/aldehyde resin is different from formaldehyde.

The term “devoid of formaldehyde” is understood to mean that the content by weight of formaldehyde, by total weight of the aldehyde or aldehydes, is strictly less than 1%.

In some embodiments, the composition can comprise formaldehyde. Preferably, the composition then comprises a content by weight of formaldehyde, by total weight of the aldehyde or aldehydes, of less than or equal to 10%, preferably of less than or equal to 5% and more preferably of less than or equal to 2%.

### I.2—Polyphenol

The second constituent of the phenol/aldehyde resin is a polyphenol comprising one or more aromatic nucleus/nuclei.

In the case of a polyphenol comprising just one aromatic nucleus, the latter bears two or three hydroxyl functional groups in the meta position with respect to each other (in the case of two functional groups) or with respect to one another (in the case of three functional groups), the remainder of the aromatic nucleus being by definition unsubstituted; this is understood to mean that the other carbon atoms of the remainder of the aromatic nucleus (those other than the carbon atoms bearing hydroxyl functional groups) bear a simple hydrogen atom.

Mention may in particular be made, as preferred example of polyphenol comprising just one aromatic nucleus, of resorcinol, as a reminder of expanded formula:

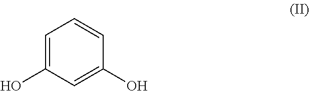

Mention may be made, as even more preferred example comprising just one aromatic nucleus, of phloroglucinol, as a reminder of expanded formula:

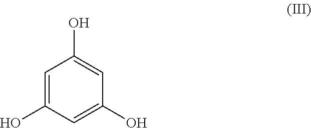

In the case of a polyphenol comprising several (two or more than two) aromatic nuclei, at least two of them each bear two or three hydroxyl functional groups in the meta position with respect to each other (in the case of two functional groups) or with respect to one another (in the case of three functional groups), it being understood that the two positions ortho to at least one of these hydroxyl functional groups are unsubstituted; this is understood to mean that the two carbon atoms located on either side of (in the ortho position to) the hydroxylated carbon atom (i.e., bearing the hydroxyl functional group) bear a simple hydrogen atom.

As preferred examples, in the case where the polyphenol molecule comprises several aromatic nuclei, at least two of these aromatic nuclei, which are identical or different, are selected from those of general formulae:

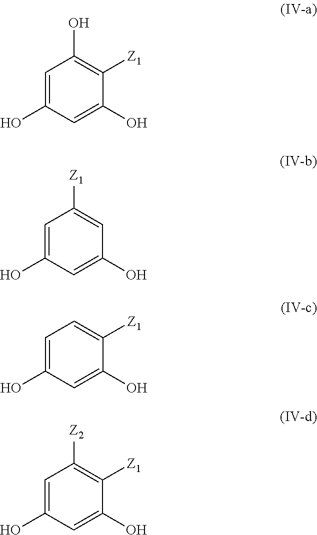

in which the Z₁ and Z₂ symbols, which are identical or different, if they are several on the same aromatic nucleus, represent an atom (for example, carbon, sulphur or oxygen) or a connecting group, by definition at least divalent, which connects at least these two aromatic nuclei to the remainder of the polyphenol molecule.

According to a specific and preferred embodiment of the invention, the polyphenol is, for example, a flavonoid, characterized, as a reminder, by a structure based on 15 carbon atoms, formed by two benzene rings connected via three carbon atoms. More particularly, the flavonoid used is 2′,4′,3,5,7-pentahydroxyflavone, also called “morin”, of formula (V) below:

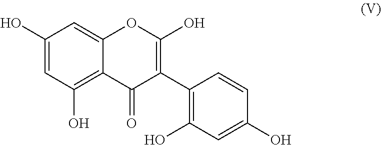 [SMILES: O=c1c(-c2ccc(O)cc2O)c(O)oc2cc(O)cc(O)c12]

It is noted that this compound is a polyphenol comprising two aromatic nuclei (of respective formulae IV-c and IV-d above), each of which indeed bears two hydroxyl functional groups in the meta position with respect to each other, the two positions ortho to at least one of these two hydroxyl functional groups being unsubstituted.

According to another specific and preferred embodiment of the invention, the polyphenol is, for example, phloroglucide, also called 2,4,6,3′,5′-biphenylpentol, of following expanded formula:

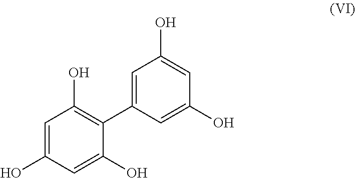 [SMILES: Oc1cc(O)cc(-c2c(O)cc(O)cc2O)c1]

It is noted that this compound is a polyphenol comprising two aromatic nuclei (of respective formulae IV-a and IV-b above), each of which indeed bears at least two (in the case in point, one bears two and the other bears three) hydroxyl functional groups in the meta position with respect to each other, the two positions ortho to at least one of these two hydroxyl functional groups being unsubstituted.

According to yet another specific and preferred embodiment of the invention, the polyphenol is, for example, 2,2′,4,4′-tetrahydroxydiphenyl sulphide, of following expanded formula:

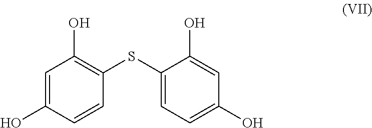 [SMILES: Oc1ccc(Sc2ccc(O)cc2O)c(O)c1]

In a preferred embodiment, the polyphenol is selected from the group consisting of phloroglucinol (III), 2,2′,4,4′-tetrahydroxydiphenyl sulphide (VII) and the mixtures of these compounds.

### I.3—Unsaturated Elastomer Latex

It should be remembered that a latex is a stable dispersion of microparticles of elastomer(s) in suspension in an aqueous solution.

Unsaturated (that is to say, bearing carbon-carbon double bonds) elastomer latexes, in particular diene elastomer latexes, are well-known to a person skilled in the art.

In accordance with the invention, the adhesive composition comprises at least one (that is to say, one or more) unsaturated elastomer latex. The unsaturated elastomer of the latex is preferably a diene elastomer, more preferably a diene elastomer selected from the group consisting of polybutadienes, butadiene copolymers, polyisoprenes, isoprene copolymers and the mixtures of these elastomers. It is more preferably still selected from the group consisting of butadiene copolymers, vinylpyridine/styrene/butadiene terpolymers, natural rubber and the mixtures of these elastomers.

Such an unsaturated elastomer latex is dispersed in the resin and forms anchoring points for the sulphur, thus providing good bonding between the adhesive layer and the rubber matrix in which the reinforcing element is intended to be embedded. Such latex also exhibits the advantage of being relatively supple and flexible, which makes it possible to accompany the deformations of the reinforcing element without the adhesive layer splitting. Finally, such a latex exhibits the advantage of exhibiting crude tackiness with the rubber matrix in which the reinforcing element is intended to be embedded. Thus, during the manufacture of the composite, the reinforcing element coated with the adhesive composition adheres to the matrix, which does not slide around the coated reinforcing element.

### I.4—Additives—Manufacture of the Adhesive Composition

The adhesive composition and/or its phenol/aldehyde resin and/or its starting unsaturated elastomer latex can, of course, comprise all or some of the additives normal for adhesive compositions, such as those used in conventional RFL adhesives; mention will be made, for example, of bases, such as aqueous ammonia, sodium hydroxide, potassium hydroxide or ammonium hydroxide, colourants, fillers, such as carbon black or silica, antioxidants or other stabilizers.

Typically, during a first manufacturing stage, the resin itself is prepared by gradually mixing the polyphenol and the aromatic aldehyde in a basic solvent, such as an aqueous sodium hydroxide solution, preferably having a pH of between 9 and 13, more preferably between 10 and 12. The combined constituents are mixed with stirring for a time which can vary according to the temperature used and the specific composition targeted, for example for a period of time which can vary between 1 min and 6 h, at a temperature of between 15° C. and 90° C., preferably between 20° C. and 60° C.

The phenol/aldehyde resin, thus pre-condensed, is generally diluted in water so as to obtain an aqueous adhesive composition. A latex or latexes (if there are several) of unsaturated elastomer(s) is/are then added, in order to form the aqueous adhesive composition, according to a general procedure which is well-known to a person skilled in the art in the field of RFL adhesives.

For example, the constituents of the adhesive composition are added in the following order: the water, possible water-soluble additives (for example aqueous ammonia), the latex or latexes (any order) and the phenol/aldehyde resin (diluted). The combination is mixed with stirring for 1 to 30 min, for example at 23° C.

During a final manufacturing stage, the adhesive composition is generally stored at ambient temperature (23° C.) for a maturing time which can typically vary from 1 to several hours, indeed even several days, before it is finally used.

In the final adhesive composition thus prepared, the content of phenol/aldehyde resin as dry matter preferably represents between 5% and 60% by weight, more preferably between 10% and 30% by weight, of the adhesive composition dry matter.

For its part, the content of unsaturated elastomer (that is to say, the dry matter of the latex or latexes) is preferably between 40% and 95% by weight, more preferably between 70% and 90% by weight, of the dry matter of the adhesive composition.

The ratio by weight of polyphenol to aromatic aldehyde is preferably between 0.1 and 3, more preferably between 0.25 and 2.

The ratio by weight of the resin dry matter to the latex dry matter is preferably between 0.1 and 2.0, more preferably between 0.15 and 1.0.

The water content of the adhesive composition is preferably between 60% and 90%, more preferably between 60% and 85%.

Advantageously, the adhesive composition comprises a gelatin. The gelatin makes it possible to slow down the dewetting of the threadlike reinforcing elements and thus to ensure better adhesion between the bronzed steel reinforcing element and the rubber matrix. The term “gelatin” is understood to mean any mixture of proteins comprising products from the total or partial hydrolysis of collagen.

### II—Process for the Manufacture of the Coated Reinforcing Element

During the process described above, at least a portion of the steel reinforcing element is coated with the adhesive layer comprising the adhesive composition described above.

This coating stage can be carried out according to any appropriate method, in particular by any known coating technique, such as, for example, spraying, impregnation by dipping, forward progression in a bath or other equivalent technique for the deposition of a thin or ultra-thin film of composition, or also by a combination of one or more of these techniques.

The weight of dry matter of the adhesive composition deposited on one kilogram of uncoated threadlike steel reinforcing element is preferably between 2 and 100 g, more preferably between 2 and 50 g and more preferably still between 3 and 15 g.

After the stage, described above, of coating the steel reinforcing element with the adhesive composition, the coated bronzed steel reinforcing element is subjected to a first heat treatment, targeted at removing any solvent or water, at a temperature of preferably between 110° C. and 260° C., more preferably between 130° C. and 250° C., for example by passing through a tunnel oven, typically with a length of several metres, such as those commonly used for the heat treatment after sizing of textile materials with an RFL adhesive.

The anhydrous coated steel reinforcing element thus obtained is then subjected to a second heat treatment in order to terminate the crosslinking of the adhesive composition, preferably carried out in air in a tunnel oven as described above. The treatment temperature is preferably between 150° C. and 350° C. The treatment times are from a few seconds to a few minutes, according to the circumstances (for example, between 10 s and 10 min).

A person skilled in the art will know how to adjust, if appropriate, the temperature and the duration of the heat treatment above, depending on the specific conditions for implementation of the invention, in particular on the exact nature of the adhesive composition or on the nature of the steel. In particular, a person skilled in the art will have the advantage of scanning the treatment temperatures and times so as to search, by successive approximations, for the operating conditions giving the best adhesion results, for each specific embodiment of the invention.

The thickness of the layer consisting of the adhesive composition coating each threadlike reinforcing element is within an interval of values ranging from 5 to 100 μm, preferably from 5 to 50 μm and more preferably from 10 to 35 μm.

Prior to the stage of coating the steel reinforcing element with the adhesive layer comprising the adhesive composition, each threadlike reinforcing element can be subjected to treatment stages, for example stages of descaling, of wet or dry drawing or also of heat treatment. Examples of these treatment stages are described in particular in the documents US20100170624, U.S. Pat. No. 5,535,612 or JP2000219938.

### III—Composite

As indicated above, the present invention also relates to the use, for the adhesion of the steel reinforcing element to a rubber matrix, of the adhesive composition described above, for formation of a rubber composite reinforced with such an element, which constitutes another subject-matter of the invention.

This rubber composite can be prepared according to a process comprising at least the following stages:
during a first stage, combining at least a portion of the coated steel reinforcing element according to the invention with a rubber matrix (or elastomer; the two terms are synonymous) to form a rubber composite reinforced with the coated bronzed steel reinforcing element;
then, during a second stage, crosslinking the composite thus formed by curing, preferably under pressure.

The invention thus applies to any type of rubber composite capable of being obtained by the process described above, comprising at least a rubber matrix, in particular a diene elastomer matrix, bonded to the steel reinforcing element via an adhesive interphase based on the adhesive composition described above.

The diene elastomer of the composite is preferably selected from the group consisting of polybutadienes (BRs), natural rubber (NR), synthetic polyisoprenes (IRs), butadiene/styrene copolymers (SBRs), isoprene/butadiene copolymers (BIRs), isoprene/styrene copolymers (SIRs), butadiene/styrene/isoprene copolymers (SBIRs) and the mixtures of these elastomers. A preferred embodiment consists in using an “isoprene” elastomer, that is to say an isoprene homopolymer or copolymer, in other words a diene elastomer selected from the group consisting of natural rubber (NR), synthetic polyisoprenes (IRs), the various copolymers of isoprene and the mixtures of these elastomers. The isoprene elastomer is preferably natural rubber or a synthetic polyisoprene of the cis-1,4 type.

### IV—Tyre

The coated steel reinforcing element and the composite which are described above can advantageously be used to reinforce tyres for all types of vehicles, in particular passenger vehicles or industrial vehicles, such as heavy-duty vehicles.

By way of example, the single appended FIGURE represents very diagrammatically (without observing a specific scale) a radial section of a tyre in accordance with the invention for a vehicle of the heavy-duty type.

This tyre 1 comprises a crown 2 reinforced by a crown reinforcement or belt 6, two sidewalls 3 and two beads 4, each of these beads 4 being reinforced with a bead thread 5. The crown 2 is surmounted by a tread, not represented in this diagrammatic FIGURE. A carcass reinforcement 7 is wound around the two bead threads 5 in each bead 4, the turn-up 8 of this reinforcement 7 being, for example, positioned towards the outside of the tyre 1, which is here represented fitted onto its wheel rim 9. The carcass reinforcement 7 is, in a way known per se, composed of at least one ply reinforced by “radial” cords, for example of metal, that is to say that these cords are positioned virtually parallel to one another and extend from one bead to the other so as to form an angle of between 80° and 90° with the median circumferential plane (plane perpendicular to the axis of rotation of the tyre which is located halfway between the two beads 4 and passes through the middle of the crown reinforcement 6).

This tyre 1 of the invention has, for example, the characteristic that at least a crown reinforcement 6 and/or its carcass reinforcement 7 comprises a coated steel reinforcing element or a composite according to the invention. According to another possible implementational example of the invention, it is, for example, the bead threads 5 which might be composed, in all or in part, of a coated steel reinforcing element according to the invention.

Of course, the invention relates to the objects described above, namely the coated steel reinforcing element and the rubber composite, such as tyre, comprising it, both in the raw state (before curing or vulcanization) and in the cured state (after curing).

### V—Implementational Examples of the Invention and Comparative Tests

These tests demonstrate that:
the adhesion to a rubber matrix of bronzed steel reinforcing elements coated with an adhesive composition according to the invention is greatly improved in comparison with these same steel reinforcing elements coated with a conventional RFL adhesive, and
the adhesive composition makes possible the adhesion of the steel reinforcing elements to any rubber matrix, in particular non-acrylic rubber matrices, without use of halogenated polymer or of metal oxide (contrary to EP 2 006 341).

For this, several adhesive compositions, denoted C-1.1 to C-1.7 below, were prepared as indicated above. Their formulations (expressed as percentage by weight) are presented in the appended Table 1. The amounts listed in this table are those of the constituents in the dry state, with respect to a total of 100 parts by weight of adhesive composition (that is to say, the constituents plus the water).

Each adhesive composition C-1.1 to C-1.7 is based on an aromatic aldehyde, the nucleus of which bears two aldehyde functional groups.

The aldehydes of the compositions C-1.1 to C-1.6 are selected from the group consisting of 1,2-benzenedicarboxaldehyde, 1,3-benzenedicarboxaldehyde, 1,4-benzenedicarboxaldehyde, 2-hydroxybenzene-1,3,5-tricarbaldehyde and the mixtures of these compounds. In the case in point, the aldehyde is selected from the group consisting of 1,2-benzenedicarboxaldehyde, 1,3-benzenedicarboxaldehyde and 1,4-benzenedicarboxaldehyde.

The aldehyde of the composition C-1.7 is selected from the group consisting of furfuraldehyde, 2,5-furandicarboxaldehyde and the mixtures of these compounds. In the case in point, the aldehyde is 2,5-furandicarboxaldehyde.

The polyphenols of the compositions C-1.1 to C-1.7 comprise one or more aromatic nucleus/nuclei, it being understood that:
in the case of just one aromatic nucleus (case of phloroglucinol and resorcinol), the latter bears two or three hydroxyl functional groups in the meta position with respect to each other or with respect to one another, the remainder of the aromatic nucleus being unsubstituted;
in the case of several aromatic nuclei (case of 2,2′,4,4′-tetrahydroxydiphenyl sulphide, of phloroglucide and of morin), at least two of them each bear two or three hydroxyl functional groups in the meta position with respect to each other or with respect to one another, it being understood that the two positions ortho to at least one of these hydroxyl functional groups are unsubstituted.

These adhesive compositions C-1.1 to C-1.7 comprise at least one unsaturated elastomer latex, in this instance a blend of several elastomer latexes: a natural rubber (NR) latex, a styrene/butadiene copolymer (SBR) latex and a vinylpyridine/styrene/butadiene (VP-SBR) latex.

In addition, each composition C-1.1 to C-1.7 comprises a gelatin.

These adhesive compositions were compared with a known composition C-1.0 of the state of the art comprising formaldehyde and resorcinol (in the form of a pre-condensed resin SFR 1524).

The quality of the bonding between the rubber matrix and the steel reinforcing element is determined by a test in which the force necessary to extract a bronzed steel reinforcing element, consisting of a single threadlike reinforcing element with a diameter equal to 1.75 mm, from the vulcanized rubber matrix is measured.

Steel reinforcing elements, the steel of the core of a threadlike reinforcing element which is directly coated with a layer of a metal coating, are compared. The steel used is a standard steel comprising less than 0.5% by weight of chromium and less than 2% by weight nickel. The metal of the metal coating layer is chosen from zinc, copper and the alloys of these metals. In this instance, the metals of the metal coatings tested are zinc and brass. The brass used comprises between 50% and 75% by weight of copper and between 25% and 50% by weight of zinc. In the case in point, the brass used comprises 63% by weight of copper and 37% by weight of zinc.

In this instance, each threadlike reinforcing element tested is devoid of nonmetallic intermediate adhesive layer.

The rubber composition of the rubber matrix is a conventional composition which can be used for the calendering of metal plies of tyres, based on natural rubber, carbon black and the standard additives. In the case in point, the rubber composition comprises 100 phr of natural rubber, 70 phr of series 300 carbon black, 1.5 phr of N-(1,3-dimethylbutyl)-N-phenyl-para-phenylenediamine, 1 phr of a cobalt salt, 0.9 phr of stearic acid, 6 phr of insoluble molecular sulphur, 0.8 phr of N-(tert-butyl)-2-benzothiazolesulphamide and 7.5 phr of ZnO.

The threadlike reinforcing element was coated with each adhesive composition tested. More specifically, the metal coating layer was coated directly with each adhesive composition tested and then the steel reinforcing elements thus coated were dried in a drying oven at 180° C. for 30 s. The adhesive composition was then crosslinked by passing the coated bronzed steel reinforcing elements through a treatment oven at 240° C. for 30 s. The assembly was then rendered integral by curing with a rubber matrix, by virtue of a vulcanization heat treatment, to form test specimens of composites as described below.

More specifically, the vulcanized rubber matrix is a rubber block consisting of two sheets measuring 200 mm by 12.5 mm and with a thickness of 7 mm, applied against each other before curing (the thickness of the resulting block is then 14 mm). It is during the production of this block that the coated steel reinforcing elements (15 sections in total) are trapped between the two rubber sheets in the raw state, an equal distance apart and while leaving to protrude, on either side of these sheets, an end of the coated steel reinforcing element having a length sufficient for the subsequent tensile test. The block comprising the coated steel reinforcing elements is then placed in a suitable mould and then cured under pressure. The curing temperature and the curing time are adapted to the intended test conditions and left to the discretion of a person skilled in the art; by way of example, in the present case, the block is cured at 160° C. for 20 min.

On conclusion of the curing, the test specimen, thus consisting of the vulcanized block and the 15 sections of coated steel reinforcing elements, is placed between the jaws of a suitable tensile testing machine in order to make it possible to test each section individually, at a given rate and a given temperature (for example, in the present case, at 100 mm/min and 23° C.).

The adhesion levels are characterized by measuring the “tearing-out” force (denoted by Fₘₐₓ) for tearing the coated steel reinforcing elements out of the test specimen. A value greater than that for the control test specimen (corresponding to the use of the conventional RFL adhesive C-1.0), arbitrarily set at 100, indicates an improved result, that is to say, a greater tearing-out force than that for the control test specimen. The results of the tests carried out on the test specimens are summarized in Table 1. When a test was not carried out, the note “NT” for not tested has been shown.

It is found that the steel reinforcing elements coated with the adhesive compositions C-1.1 to C-1.7 exhibit a tearing-out force Fₘₐₓ which is particularly high and unexpected for a person skilled in the art since it is very much increased with respect to a conventional RFL adhesive of the composition C-1.0, without, however, using a matrix of specific rubber, of halogenated polymer and of metal oxide.

Among the other advantages related to the invention, it should be noted that the adhesive composition can be devoid of formaldehyde, the use of which it is desirable to reduce, indeed even eventually to eliminate, in adhesive compositions, due to the recent change in European regulations regarding this type of compound. In addition, formaldehyde is a compound derived from oil, the use of which it is desired to avoid as much as possible for reasons of increased scarcity.

The invention is not limited to the embodiments described above.

It will also be possible to envisage coating several threadlike reinforcing elements each comprising a steel core. In one embodiment, the threadlike reinforcing elements are assembled together and then the threadlike reinforcing elements are collectively coated with the adhesive composition. In another embodiment, each threadlike reinforcing element is coated individually with the adhesive composition and then the threadlike reinforcing elements are assembled together.

It will also be possible to envisage the use of coated steel reinforcing elements comprising a nonmetallic intermediate adhesive layer directly coating the steel core of the threadlike reinforcing elements or the metal coating layer, the layer of the adhesive composition then directly coating this nonmetallic intermediate adhesive layer or the metal coating layer.

TABLE 1

| | | | | | | | | |
|---|---|---|---|---|---|---|---|---|
| Adhesive compositions | C-1.0 | C-1.1 | C-1.2 | C-1.3 | C-1.4 | C-1.5 | C-1.6 | C-1.7 |

Aldehyde

| | | | | | | | | |
|---|---|---|---|---|---|---|---|---|
| 1,2-Benzenedicarboxaldehyde (1) | — | — | 0.9 | — | — | — | — | — |
| 1,3-Benzenedicarboxaldehyde (2) | — | — | — | — | 0.9 | — | — | — |
| 1,4-Benzenedicarboxaldehyde (3) | — | 0.9 | — | 0.9 | — | 0.9 | 0.9 | — |
| 2,5-Furandicarboxaldehyde (4) | — | — | — | — | — | — | — | 0.9 |
| Formaldehyde (5) | 0.71 | — | — | — | — | — | — | — |

Polyphenol

| | | | | | | | | |
|---|---|---|---|---|---|---|---|---|
| Phloroglucinol (6) | — | 1.7 | — | — | — | — | — | — |
| 2,2′,4,4′-Tetrahydroxydiphenyl | — | — | 1.7 | 1.7 | — | — | — | — |
| sulphide (7) | | | | | | | | |
| Phloroglucide (8) | — | — | — | — | 1.7 | 1.7 | — | — |
| Morin (9) | — | — | — | — | — | — | 1.7 | |
| Resorcinol (10) | — | — | — | — | — | — | — | 1.7 |
| SRF 1524 (11) | 2.05 | — | — | — | — | — | — | — |

Elastomer latex

| | | | | | | | | |
|---|---|---|---|---|---|---|---|---|
| NR (12) | 6.4 | 6.4 | 6.4 | 6.4 | 6.4 | 6.4 | 6.4 | 6.4 |
| SBR (13) | 3.2 | 3.2 | 3.2 | 3.2 | 3.2 | 3.2 | 3.2 | 3.2 |
| VP-SBR (14) | 6.4 | 6.4 | 6.4 | 6.4 | 6.4 | 6.4 | 6.4 | 6.4 |

Additives

| | | | | | | | | |
|---|---|---|---|---|---|---|---|---|
| Sodium hydroxide (15) | 0.2 | 0.2 | 0.2 | 0.2 | 0.2 | 0.2 | 0.2 | 0.2 |
| Gelatin (16) | 1 | 1 | 1 | 1 | 1 | 1 | 1 | 1 |
| Aqueous ammonia (17) | 0.5 | 0.5 | 0.5 | 0.5 | 0.5 | 0.5 | 0.5 | 0.5 |
| Total weight of dry matter of | 19.5 | 20.3 | 20.3 | 20.3 | 20.3 | 20.3 | 20.3 | 20.3 |
| adhesive composition | | | | | | | | |
| Weight of water | 80.5 | 79.7 | 79.7 | 79.7 | 79.7 | 79.7 | 79.7 | 79.7 |

Adhesion tests

| | | | | | | | | |
|---|---|---|---|---|---|---|---|---|
| Fₘₐₓ at 23° C. (Zinc-coated steel) | 100 | 655 | 292 | 473 | 497 | 396 | 592 | 468 |
| Fₘₐₓ at 23° C. (Brass-coated steel) | 100 | 120 | 126 | 117 | 119 | NT | 124 | 117 |

(1) 1,2-Benzenedicarboxaldehyde (from ABCR; purity of 98%);
(2) 1,3-Benzenedicarboxaldehyde (from ABCR; purity of 98%);
(3) 1,4-Benzenedicarboxaldehyde (from ABCR; purity of 98%);
(4) 2,5-Furandicarboxaldehyde (from Aldrich; purity of 97%);
(5) Formaldehyde (from Caldic; diluted to 36%);
(6) Phloroglucinol (from Alfa Aesar; purity of 99%);
(7) 2,2′,4,4′-Tetrahydroxydiphenyl sulphide (from Alfa Aesar; purity of 98%);
(8) Phloroglucide (from Alfa Aesar; purity of 95%);
(9) Morin (from Fluka);
(10) Resorcinol (from Sumitomo; purity of 99.5%);
(11) Pre-condensed resin SRF 1524 (from Schenectady; diluted to 75%);
(12) NR Latex (“Trang Latex” from Bee tex; diluted to 61% by weight);
(13) SBR Latex (“Encord-201” from Jubilant; diluted to 41% by weight);
(14) Vinylpyridine/styrene/butadiene latex (“VP 106S” from Eliokem; diluted to 41%);
(15) Sodium hydroxide (from Aldrich; diluted to 30%);
(16) Gelatin (gelatin from bovine skin from Aldrich);
(17) Aqueous ammonia (from Aldrich; diluted to 21%).

1.-18. (canceled)

19. A coated steel reinforcing element coated with an adhesive layer coating at least a portion of the reinforcing element, wherein the adhesive layer comprises an adhesive composition comprising:
at least one unsaturated elastomer latex; and
at least one phenol/aldehyde resin based on at least:
one aromatic aldehyde bearing at least one aldehyde functional group and comprising at least one aromatic nucleus; and
one polyphenol comprising one or more aromatic nucleus/nuclei,
wherein, if there is only one aromatic nucleus, the one aromatic nucleus bears two or three hydroxyl functional groups in the meta position with respect to each other or with respect to one another, the remainder of the aromatic nucleus being unsubstituted, and
wherein, if there is more than one aromatic nuclei, at least two of them each bear two or three hydroxyl functional groups in the meta position with respect to each other or with respect to one another and the two positions ortho to at least one of these hydroxyl functional groups are unsubstituted.

20. The coated steel reinforcing element according to claim 19, further comprising one or more threadlike reinforcing elements, each comprising a steel core.

21. The coated steel reinforcing element according to claim 20, wherein the adhesive layer directly coats a layer of a metal coating directly coating at least a portion of the steel core of the or each threadlike reinforcing element.

22. The coated steel reinforcing element according to claim 21, wherein the metal of the layer of the metal coating directly coating at least a portion of the steel core of the or each threadlike reinforcing element is chosen from zinc, copper and alloys thereof.

23. The coated steel reinforcing element according to claim 20, wherein the adhesive layer directly coats a nonmetallic intermediate adhesive layer coating the steel core of the or each threadlike reinforcing element.

24. The coated steel reinforcing element according to claim 19, wherein the aromatic aldehyde bears at least two aldehyde functional groups.

25. The coated steel reinforcing element according to claim 19, wherein the at least one aromatic nucleus of the aromatic aldehyde bears two aldehyde functional groups.

26. The coated steel reinforcing element according to claim 19, wherein the at least one aromatic nucleus of the aromatic aldehyde is a benzene nucleus.

27. The coated steel reinforcing element according to claim 26, wherein the aromatic aldehyde is selected from the group consisting of 1,2-benzenedicarboxaldehyde, 1,3-benzenedicarboxaldehyde, 1,4-benzenedicarboxaldehyde, 2-hydroxybenzene-1,3,5-tricarbaldehyde and mixtures thereof.

28. The coated steel reinforcing element according to claim 27, wherein the aromatic aldehyde is 1,4-benzenedicarboxaldehyde.

29. The coated steel reinforcing element according to claim 19, wherein the aromatic aldehyde is of general formula (A): 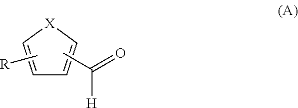
in which X comprises N, S or O, and R represents —H or —CHO.

30. The coated steel reinforcing element according to claim 29, wherein the aromatic aldehyde is selected from the group consisting of furfuraldehyde, 2,5-furandicarboxaldehyde and mixtures thereof.

31. The coated steel reinforcing element according to claim 19, wherein the polyphenol is selected from the group consisting of phloroglucinol, 2,2′,4,4′-tetrahydroxydiphenyl sulphide and mixtures thereof.

32. The coated steel reinforcing element according to claim 19, wherein the unsaturated elastomer of the latex is a diene elastomer.

33. The coated steel reinforcing element according to claim 32, wherein the diene elastomer is selected from the group consisting of polybutadienes, butadiene copolymers, polyisoprenes, isoprene copolymers, vinylpyridine/styrene/butadiene terpolymers and mixtures thereof.

34. A process for the manufacture of a steel reinforcing element coated at least in part with an adhesive layer comprising the step of:
coating at least a portion of the steel reinforcing element with the adhesive layer, wherein the adhesive layer comprises an adhesive composition comprising:
at least one unsaturated elastomer latex; and
at least one phenol/aldehyde resin based on at least:
one aromatic aldehyde bearing at least one aldehyde functional group and comprising at least one aromatic nucleus; and
one polyphenol comprising one or more aromatic nucleus/nuclei,
wherein, if there is only one aromatic nucleus, the one aromatic nucleus bears two or three hydroxyl functional groups in the meta position with respect to each other or with respect to one another, the remainder of the aromatic nucleus being unsubstituted, and
wherein, if there is more than one aromatic nuclei, at least two of them each bear two or three hydroxyl functional groups in the meta position with respect to each other or with respect to one another and the two positions ortho to at least one of these hydroxyl functional groups are unsubstituted.

35. A method of adhering a steel reinforcing element to a rubber matrix comprising the step of:
forming an adhesive layer by coating, at least in part, the steel reinforcing element with an adhesive composition comprising:
at least one unsaturated elastomer latex; and
at least one phenol/aldehyde resin based on at least:
one aromatic aldehyde bearing at least one aldehyde functional group, comprising at least one aromatic nucleus; and
one polyphenol comprising one or more aromatic nucleus/nuclei,
wherein, if there is only one aromatic nucleus, the one aromatic nucleus bears two or three hydroxyl functional groups in the meta position with respect to each other or with respect to one another, the remainder of the aromatic nucleus being unsubstituted, and
wherein, if there is more than one aromatic nuclei, at least two of them each bear two or three hydroxyl functional groups in the meta position with respect to each other or with respect to one another and the two positions ortho to at least one of these hydroxyl functional groups are unsubstituted.

36. A rubber composite comprising a rubber matrix in which at least one coated steel reinforcing element according to claim 19 is embedded.

37. A tire comprising at least one coated steel reinforcing element according to claim 19.

38. A tire comprising a rubber composite according to claim 36.
